(19) United States
(12) Patent Application Publication
(10) Pub. No.: US 2009/0246747 A1
(43) Pub. Date: Oct. 1, 2009

(54) SIMULATOR FOR MAJOR SURGICAL OPERATIONS

(75) Inventor: Robert F. Buckman, JR., Elkton, MD (US)

Correspondence Address: HOWSON & HOWSON LLP, 501 OFFICE CENTER DRIVE, SUITE 210, FORT WASHINGTON, PA, 19034, US

(73) Assignee: OPERATIVE EXPERIENCE, INC., Elkton, MD (US)

(21) Appl. No.: 12/410,670

(22) Filed: Mar. 25, 2009

Related U.S. Application Data
(60) Provisional application No. 61/039,202, filed on Mar. 25, 2008.

(51) Int. Cl. G09B 23/30

(52) U.S. Cl. 434/272

(57) ABSTRACT

The invention consists of a hands-on, physically simulated human or animal body interior, containing physically simulated representations of all of the solid organs, hollow viscera, bladders, glands, major ducts, large and medium-sized blood vessels, muscle groups and interstitial tissues. The organs and vessels are life-sized and are composed of molded or sculpted open cell or closed cell foam rubber of varying density and load deformation, matching the physical properties of the specific biologic organs or tissues simulated. The organs, tissues and vessels may be treated with pigments, sealants and/or hardening agents to reflect the contours, appearances, densities, textures, elasticity, and deformability of normal or pathologically-altered internal organs and tissues. Organs contain molded vascular channels, reversibly attached to the larger blood vessels of the simulator. The model has a pressurized, watertight, simulated vascular system, monitored by electronic sensors.

### CROSS-REFERENCE TO RELATED APPLICATION

This application claims priority on the basis of Provisional patent application No. 61/039,202, filed Mar. 25, 2008.

### FIELD OF THE INVENTION

The present invention relates to an improved, hands-on, physical simulator for the demonstration and/or practice of major surgical operations on the internal tissues, organs and blood vessels of human or animal bodies.

### BACKGROUND OF THE INVENTION

Major operations include, but are not limited to, those involving entry into the cranium, chest cavity, abdominal cavity, deep planes of the neck, or the deep intermuscular planes of the extremities. Major operations commonly require surgical dissection of structures within the body, retraction of tissues, organs and vessels, surgical manipulation of internal body structures, using hands or instruments, and the repair, removal or rearrangement of the internal anatomy by the surgeon. Other major operations are carried out by endovascular techniques, that is, entry into the great vessels of the chest or abdomen by threading a catheter through a femoral or brachial artery. There is a strong need for surgical trainees to learn and practice the performance of such major operations. However, opportunities of gain sufficient clinical experience with these procedures are limited in current surgical training. The existence of a simulated body with operable tissues would permit a valuable expansion of operative surgical training. Some examples of major operations include:
craniotomy or craniectomy for the evacuation of blood clots on the brain;
exploration of the tissues and structures within the neck, repair of a carotid artery or internal jugular vein, repair of injuries to the trachea or esophagus, thyroidectomy, parathyroidectomy;
exploration of the chest cavity through major lateral chest incisions, median sternotomy or thoracoscopy, the repair or resection of major intrathoracic structures, including the heart, major blood vessels, the lungs or the esophagus;
exploration of the abdominal contents with operative manipulation of the major abdominal viscera including the liver, spleen, stomach, pancreas, small and large bowel or major abdominal blood vessels, the repair or resection of the abdominal viscera or vessels, open or endoscopic exploration of the common bile duct;
the exploration of the tissues of the extremities, including, the exposure of major blood vessels and nerves, muscle compartment fasciotomy, the repair of injured blood vessels, or surgical amputation of the arm, forearm or leg; and
endovascular placement of grafts for the repair of aortic aneurysms due to degenerative diseases or trauma.

The operations listed above, while not all-inclusive, indicate the scale and complexity of operation that we would consider “major.” Such operations as tracheotomy, placement of a central venous catheter, chest tube insertion, diagnostic peritoneal lavage or pericardiocentesis, would not, in this definition, be considered “major.” Simulators exist for the performance of these latter procedures and for cholecystectomy and inguinal hernia repair. Such simulators do not contain anatomically correct, surgical environments in which organs and tissues must be mobilized and retracted in order to visualize the area requiring operative repair or resection. In this respect, they are unrealistic, and permit practice of only a fraction of a major surgical operation.

Crudely formed, single layer, silicone rubber gallbladders, stomachs, bowels and blood vessels, without significant anatomic detail and without accurate anatomic environments, already exist on the marketplace and are sold by Simulab and other companies. The prior art contains several references to hands-on simulators.

The simulators described in United States Patent Publications 2004/0126746, 2005/0026125, 20050064378, and 2006/0232664 are considered the most relevant to the present invention, but appear to be completely composed of various formulations of silicone rubber. They do not have the features described in the disclosure below.

Similarly, representations of the internal anatomy of the body molded in a plastic or hard rubber, without the elasticity, deformability, or anatomic details characteristic of biologic tissues lack the unique features of the invention of the present disclosure.

### SUMMARY OF THE INVENTION

In accordance with one aspect of the invention, the simulator may include a molded or sculpted shell consisting of coated and structurally reinforced open or closed cell foam, or similar materials, in the form of a human or animal body surface, with representations of the muscular, bony, and fascial layers of the body wall. Bonding and/or isolation materials may be used to join or to separate areas, layers, or planes of the body wall.

The entire apparatus is made of materials, as described below that mimic the individual mechanical properties of the several types of biologic tissue, including the skin, subcutaneous tissue, muscle, fascia, solid and hollow organs, glands, arteries, veins and nerves comprising a mammalian body.

The anatomic elements that comprise the internal structures of the simulated body form a physical, hands-on surgical simulator that can be used to demonstrate or practice major operations, including those done by open, endoscopic or endovascular techniques.

### BRIEF DESCRIPTION OF THE DRAWINGS

FIG. 1A is a schematic view of a simulated stomach composed of an inner layer of viscoelastic polyurethane foam rubber and an outer layer of silicone sealant;

FIG. 1B is a cross-sectional view taken on plane A1 in FIG. 1A, showing molded simulations of pathological conditions, for example tumors or ulcers, on the simulated mucosa and submucosa;

FIG. 2 is a schematic view Illustrating the reversible integration of cadaveric human or animal tissue into the architecture of the simulator through the use of hollow tubular connectors;

FIG. 3 is a schematic view illustrating the reversible attachment of one of various internal organs containing molded, watertight vascular channels, to the vascular network of the simulator by means of hollow tubular connectors; and

FIG. 4 is a schematic view illustrating a fluid filled, pressurized, vascular network within the infrastructure of the simulator, including one of various internal organs, in which pressure and flow sensors in the walls of the simulated great vessels monitor blood pressure within the vascular circuit, and in which Simulated rupture of a vascular channel molded within the internal organ creates hemorrhage.

### DETAILED DESCRIPTION OF THE PREFERRED EMBODIMENTS

The anatomic parts that make up the simulator of the present invention are realistic representations of the three-dimensional internal anatomy of the animal or human body. Unlike the structure of prior simulators, the anatomic structures of the present invention have been sculpted, molded or carved from open or closed cell foam rubber of varying density, elasticity and load-deformation to match the physical characteristics of the specific, simulated organ or tissue. In a preferred embodiment, the material will be viscoelastic (memory), polyurethane foam. While a variety of closed or open cell foam materials, including latex foam, silicone foam rubber or other materials may be suitable for various parts of the simulator, most anatomic elements of the simulator will be made of viscoelastic, polyurethane foam.

The widely-varying density, texture and load-deformability of actual human organs and tissues, whether normal or diseased, are stimulated by varying the density of the foam rubber and/or by treatment with pigments, sealants or impregnating materials to represent the physical properties of the specific organ or tissue within the simulator.

The open or closed cell foam of any organ, tissue or blood vessel may be, in whole or in part, treated with a variety of sealants, pigments or impregnating, glues, hardening agents, solids or gels, so that the textures and appearances of a large variety of normal or pathologic human organs and tissues can be simulated. The sealants may be, by way of example, silicone rubber, vinyl, latex or other high tech sealants. The foam may be impregnated or coated with materials such as plaster, fiberglass resin, plastic, epoxy or other, similar hardening agents.

Hollow organs and structures, including the trachea, esophagus, stomach and intestines, as well as the gallbladder and urinary bladder and the associated ducts are composed of two layers: an inner layer of viscoelastic, memory foam, representing the mucosa and submucosa, and an outer layer or coating, representing the muscular layers of the visceral wall. In the preferred embodiment, the coating for the viscoelastic foam will be silicone or latex. Acrylic, vinyl or polyurethane-based coatings may be used to provide stiffness to the trachea and larynx.

The interstitial, or connecting, tissues, the loose, fibrous tissues filling the spaces between major muscle groups, organs and blood vessels represent the planes through which most surgical dissection is typically performed. In the simulator of the present invention, interstitial tissues are represented using one or more layers of non-woven, thin, fibrous fabric or cellulosic fibers, or non-cellulosic fibers preferably of poly (ethylene terephthalate) similar in structure to “BOUNCE” fabric softener sheets from The Procter & Gamble Company.

Membranes that are important to surgical operations, such as the peritoneum, pericardium and pleura, as well as the investing membranes of the brain, are represented in the simulator of the present invention, by one or more thin sheets or layers of viscoelastic foam material, and/or random fiber-direction fabric. These materials may be coated or impregnated with pigments, silicone or latex, or with other materials, to achieve a realistic appearance, elasticity, flexibility, texture and surgical dissectability.

Hollow, watertight, simulated vascular channels are molded into the correct anatomic position of the thoracic and abdominal aorta, the subclavian arteries, the carotid arteries, the iliac and renal arteries, the superior and inferior mesenteric arteries, the brachial and femoral arteries. In addition, hollow, watertight simulated vascular channels are molded into the chambers of the heart and into the parenchyma or “flesh” of the lungs, spleen, liver and pancreas. Similar vascular channels are molded into the anatomic position of the superior and inferior vena cava, the subclavian vein, the veins of the upper and lower extremities, and the renal, mesenteric and portal veins. These vascular channels constitute a closed pathway for artificial blood. The hollow, tubular lumens of the larger vascular channels may be reversibly connected to the corresponding vascular channels within organs. This reversible connection of the blood vessels of the organs to the major arteries and veins is accomplished by hollow, soft, tubular connectors, capable of forming a watertight seal between one blood vessel and another.

The watertight vascular channels of the simulator may be filled with simulated liquid blood, and may be connected to a pressurizing or a circulating pump. The pressure, flow and volume of the circulating artificial blood may be measured at various points within the simulator vasculature by pressure or flow sensors. In the preferred embodiment, the sensors may transmit data by wired or wireless means to a logic circuit and a display, which show the blood pressure, blood volume and blood flow of the simulated “patient.” A logic circuit can be developed, which shows the response of the blood pressure and flow to maneuvers such as operative control of hemorrhage, clamping the aorta or manually massaging the simulated heart. The ducts of major organs or glands, such as the liver or pancreas are also hollow, and are coated or sealed to be watertight. In a preferred embodiment, these major ducts will be filled with simulated body fluids, such as imitation bile or pancreatic juice.

The physically simulated organs, blood vessels, glands, ducts and tissues of the simulator of the present invention may be represented in normal or pathologically altered forms. Anatomic abnormalities caused by trauma, inflammation, neoplasm or degeneration can be simulated. For example, traumatic injuries to the internal structures of the body such as gunshot wounds, traumatic ruptures of major blood vessels, or rupture of the liver or spleen are represented by realistic patterns of disruption of the anatomic integrity of the specific tissues, vessels or organs.

Because of the vascular channels coursing through the tissues and organs, simulated traumatic disruption of the organs or vessels will be associated with simulated hemorrhage from the blood vessels in the damaged area. Thus, for example, in the simulator of the present invention, a high velocity gunshot of the thigh is not just simulated as a hole in the surface of the extremity, issuing blood. Instead, such a wound is stimulated by the destruction of the skin, subcutaneous tissues, the muscle tissues and fascia and the blood vessels of the extremity. With such a model, both the first aid measures for hemorrhage control and the operative management of such wounds can be realistically practiced.

Inflammatory, degenerative and neoplastic alteration of the tissue of the human body is accompanied by characteristic changes in the texture, size, uniformity, elasticity, density and shape of the affected organs and tissues. This phenomenon can be illustrated by a few specific examples:
1.) Tumors within the substance of the liver, pancreas or thyroid gland create a discrete lump or an abnormal area of hardness within the involved organ. The mass may deform the surface of the organ.
2.) Inflammation of the appendix, that is, appendicitis, is accompanied by swelling, redness and unnatural, rubbery firmness and reduced elasticity of the structure.
3.) An aneurysm of the abdominal aorta is associated with unnatural dilation of this major vessel.
4.) obstruction of the common bile duct is associated with dilation of the duct and with stones in the lumen or with a hard swelling in the head of the pancreas.
5.) Advanced cancer of the colon is associated with a hard, circumferential tumor, narrowing the lumen of the colon.
6.) Atherosclerotic degeneration of arteries is characterized by elevated, calcified plaques, which narrow the lumen of the vessel. Many other examples could be given.

In the simulator of the present invention, such inflammatory, neoplastic or degenerative diseases are represented by changes in the size, texture, elasticity, uniformity, density, coloration and shape of the simulated organ, vessel or tissue. Abnormal organ shapes can be molded, on the basis of sculpted primary models, in viscoelastic foam of varying density and load deformation. Tumors or inflammatory changes in tissue texture and elasticity are simulated by the impregnation or coating of the viscoelastic foam. For example, a hard, cancerous mass in the thyroid gland or the pancreas is stimulated by the impregnation of hardening agents into the cells of the viscoelastic foam in the area of simulated tumor formation. A cancerous tumor of the colon is simulated by sculpting or molding the abnormality in the wall of the colon and impregnating the “cancerous” area with polyurethane, or another liquid material that hardens upon drying. Appendicitis is stimulated by representing the tip of the appendix as abnormally increased in diameter, stained red with pigment and made unnaturally firm and rubbery by impregnating and/or coating the structure with latex or silicone rubber. Atherosclerotic degeneration of an artery can be simulated by molding an artery with a narrowed lumen out of foam rubber and locally impregnating the foam in the narrowed area with plaster or acrylic. Many other examples could be given, but the crucial techniques are disclosed: of molding viscoelastic foam into the desired shape and then altering its physical properties, in areas of pathologic alteration, to match the desired pathology, by various coatings and impregnations.

The reversible attachment of various organs such as the liver or spleen to the main blood vessels of the simulator is accomplished by soft, hollow, tubular connecting pieces or hollow dowels. These connectors mimic, as closely as possible, the physical characteristics of the simulated blood vessels into which they insert. Thus, normal organs can be reversibly replaced with organs reflecting various pathologic changes. Those organs, blood vessels, glands and tissues that have been cut, sutured, stapled or otherwise damaged, as part of the simulated operative procedure, can be replaced at the end of the practice operation through the use of these connectors. Entire anatomic regions, for example, the undersurface of the liver, gallbladder, bile ducts, pancreas and duodenum, can be molded as a single block and reversibly attached to the infrastructure of the simulated body as a unit.

Using hollow, connecting pieces or other tubular connectors, actual animal tissues, for example, blood vessels or hollow viscera may be integrated into the anatomic infrastructure of the simulator. Segments of cadaveric human or animal blood vessels, hollow viscera or other tissues can be integrated into the architecture of the simulated body so that the trainee surgeon can practice techniques on real biologic tissue within a physically simulated human body interior.

The open-cell, viscoelastic foam constituting the internal structure of the simulator described above is fully dissectible using normal surgical instruments, such as scalpels, scissors, clamps and forceps. The simulator is suitable for training in open, endoscopic or endovascular surgical procedures, using standard instruments and techniques. Moreover, because the tissues and organs of the simulator are composed of materials that mimic the texture, load-deformability and elasticity of biologic tissues, the internal structures of the simulator can be subjected to the maneuvers employed during a variety of surgical operations on all of the major internal organs, tissues and large blood vessels, including maneuvers such as sewing and stapling.

Unlike any prior, physical, hands-on simulator, the simulator of the present invention permits the demonstration and/or repeated practice of the following operative maneuvers that are components of many surgical operations:
the creation of long or short surgical incisions into the internal anatomy of body, including cranial, cervical, thoracic, abdominal or extremity incisions;
the sharp or blunt dissection, using standard surgical instruments and techniques, through the simulated tissues and fascial planes of the head, neck, chest, abdomen and extremities;
manual or mechanical retraction of simulated tissues, including simulated muscle, fascia, interstitial tissue, major vessels and internal organs;
the dissection, using standard surgical instruments and techniques, of interstitial tissue around blood vessels and internal organs, permitting the mobilization of the vessel or organ from its attachments;
the mobilization and retraction of internal organs such as the liver, spleen, pancreas, esophagus, stomach, kidneys, intestines, urinary bladder, heart and lungs;
the partial or total excision of organs and glands of the body by surgical division of their attachments, including their blood vessels, and ducts;
the clamping and surgical division of blood vessels, ducts and other hollow tubular structures within the body;
the creation of surgical anastomoses between the lumens of similar or dissimilar hollow viscera or between a duct and a hollow viscus;
the surgical repair of large blood vessels or the resection and reanastomosis of such vessels; and
the performance of endovascular procedures, including the repair of aneurysms and the placement of vena cava filters.

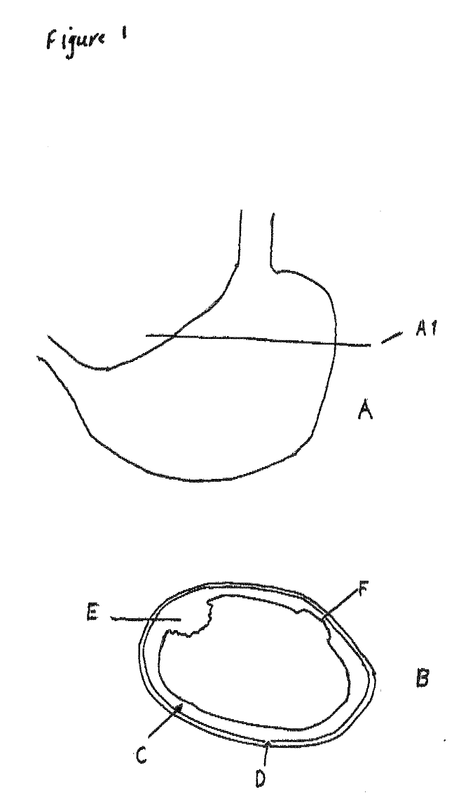

Examples of aspects of the invention are illustrated in FIGS. 1A-4 of the drawings

The simulated stomach A, seen in cross-section in FIG. 1B, has an outer layer D composed of silicone rubber, simulating the muscularis of the stomach, and a viscoelastic inner layer C, simulating the mucosa and submucosa. A tumor E of the mucosa is simulated by a hardening agent impregnated into the viscoelastic layer C. A simulated ulcer crater F is molded in the inner layer C.

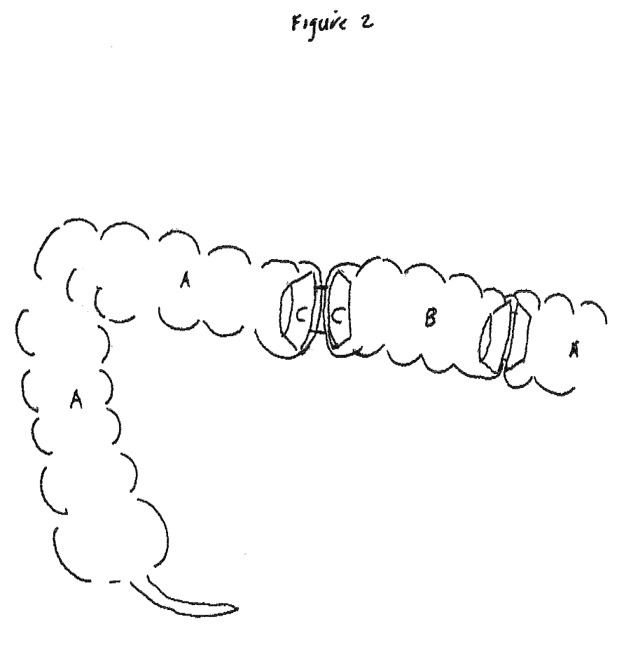

In FIG. 2, a foam rubber colon is made up of two sections A, composed of viscoelastic foam rubber, connected by a section B, which can be a section of cadaveric human or animal colon. Section B is connected to sections A by two hollow, tubular connectors, inserted into, and joining the lumens of sections A and B.

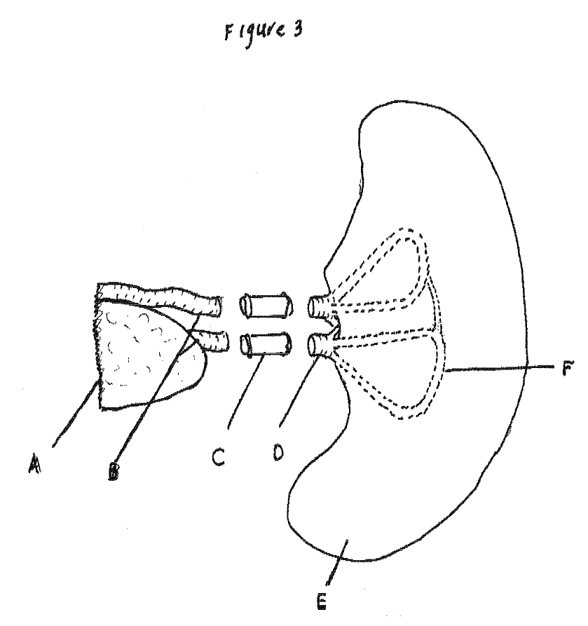

In FIG. 3, a hollow, tubular splenic artery and vein on the amputated tip A of the tail of a simulated pancreas are connected to vessels in the hilum of a simulated spleen E, shown in saggital section, by gasketed hollow tubular connections C. The vessels D are connected to watertight vascular channels F molded in the parenchyma of the spleen.

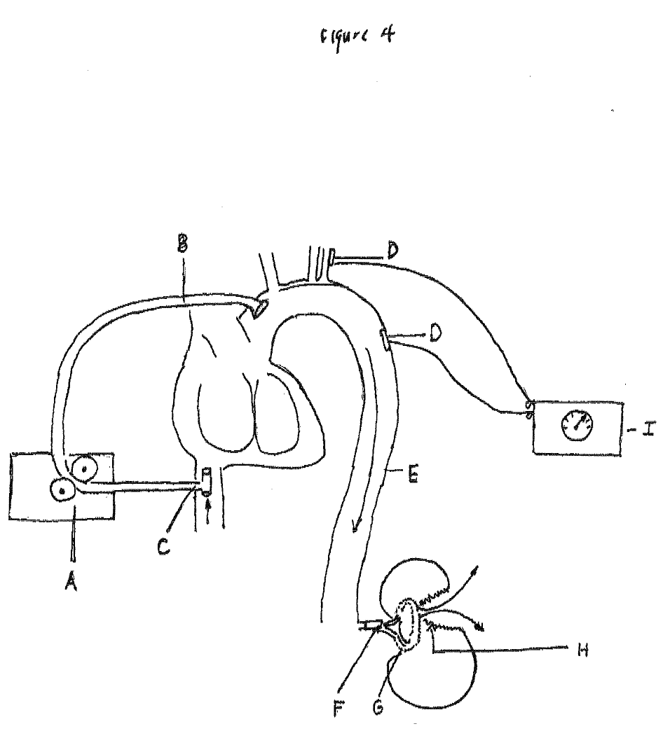

In FIG. 4, a peristaltic pump A pressurizes artificial blood in the vascular system of the simulated patient, drawing the artificial blood from the inferior vena cava through an inflow channel, and delivering the artificial blood through an outflow channel to the ascending aorta. The artificial blood flows through the watertight descending aorta E to a simulated renal artery F, which leads to molded vascular channels G in the parenchyma of a simulated kidney. The kidney and the simulated renal artery F are reversibly connected to the aorta. The kidney is formed with a simulated vascular rupture H, so that simulated blood flows as a hemorrhage from the pressurized vascular channels in the kidney.

A pressure sensor D is provided in the wall of a major vessel, in this case the left subclavian artery, and a flow sensor D is provided in the wall of the descending aorta. Outputs of the pressure sensor and the flow sensor, are connected to a monitor I.

I claim:

1. A simulated human body comprising simulated anatomical parts, said parts including parts from the group consisting of solid organs and hollow viscera, bladders, glands ducts, blood vessels and tissues, wherein at least one of said parts is pathologically altered.

2. A simulated human body according to claim 1, in which said anatomical parts include a simulated blood vessel, and in which a traumatic disruption of the simulated blood vessel is simulated by a disruption of simulated skin, simulated subcutaneous tissues, simulated muscle tissues, and simulated fascia of said blood vessel.

3. A simulated human body according to claim 2, in which simulated blood is circulated through said simulated blood vessel.

4. A simulated human body according to claim 1, in which said anatomical parts include an a simulated organ composed of viscoelastic foam, and in which a part of said simulated organ is impregnated with a hardening agent to simulate a pathological condition.

5. A simulated human body according to claim 1, in which said anatomical parts include an a simulated organ composed of viscoelastic foam, and in which a part of said simulated organ is coated with latex or silicone rubber to simulate a pathological condition.

6. A simulated human body according to claim 1, in which said anatomical parts include an a simulated vessel composed of foam rubber, and in which a part of said simulated vessel is molded to form a narrowed lumen, and impregnated with a material that increases its hardness.

7. A simulated human body according to claim 6, in which said material is a plaster, or an acrylic resin.

8. A simulated human body comprising simulated anatomical parts, said parts including a simulated anatomical vessel, said vessel including at least first and second parts, the second part being modified to simulate a pathological condition and being replaceably connected to said first part.

9. A simulated human body according to claim 8, in which said simulated anatomical vessel contains a liquid.

10. A simulated human body according to claim 8, in which said first and second parts are connected by a hollow, tubular connector.

12. A simulated human body comprising simulated anatomical parts, said parts including simulated vasculature containing a liquid, a pump connected to the simulated vasculature for causing said liquid to flow in said simulated vasculature.

13. A simulated human body according to claim 12, including at least one pressure sensor connected to said simulated vasculature, and a monitor responsive to said pressure sensor.

14. A simulated human body according to claim 12, including at least one flow sensor connected to said simulated vasculature, and a monitor responsive to said flow sensor.

15. A simulated human body according to claim 12, including at least one pressure sensor connected to said simulated vasculature at least one flow sensor connected to said simulated vasculature, and a monitor responsive to said pressure sensor and said flow sensor.
